(19) United States
(12) Patent Application Publication
(10) Pub. No.: US 2020/0367574 A1
(43) Pub. Date: Nov. 26, 2020

(54) DISPOSABLE CARTOMIZER AND ELECTRONIC CIGARETTE APPARATUS INCLUDING THE SAME

(71) Applicant: NOVO Co., Ltd., Bundang-gu (KR)

(72) Inventor: Sung Whan Choi, Yongin-si (KR)

(73) Assignee: NOVO Co., Ltd., Bundang-gu (KR)

(21) Appl. No.: 16/519,585

(22) Filed: Jul. 23, 2019

(30) Foreign Application Priority Data
May 22, 2019 (KR) 10-2019-0059935

(51) Int. Cl. A24F 47/00

(52) U.S. Cl. CPC A24F 47/008; H02J 7/0052

(57) ABSTRACT

Disclosed is a disposable cartomizer and an electronic cigarette including the same. According to an embodiment of the present invention, a first opening and closing part is brought into close contact with a first protrusion so that liquid is stored in a container in a sealed state, so it is possible to prevent the liquid from leaking while being stocked. In addition, when a vaporizer is moved upward to use the electronic cigarette, a second opening and closing part is brought into close contact with a hermetic retention recess so that the liquid is introduced into the vaporizer while the sealed state of the container is maintained and, at the same time, a third opening and closing part is brought into close contact with a second protrusion so that a lower end portion of a main body is sealed, thereby preventing the liquid from leaking to the outside.

### CROSS REFERENCE TO RELATED APPLICATION

The present application claims priority to Korean Patent Application No. 10-2019-0059935, filed May 22, 2019, the entire content of which is incorporated herein for all purposes by this reference.

### BACKGROUND OF THE INVENTION

### Field of the Invention

The present invention relates to a disposable cartomizer and an electronic cigarette including the same. More particularly, the present invention relates to a disposable cartomizer and an electronic cigarette including the same, the disposable cartomizer being configured such that liquid is stored in a container in a sealed state whereby the liquid is prevented from leaking while being stocked, and the disposable cartomizer being also configured such that when a vaporizer is moved upward to use the cartomizer, the liquid is introduced into the vaporizer while the sealed state of the container is maintained and, at the same time, a lower end portion of a main body is sealed, thereby preventing the liquid from leaking to the outside.

### Description of the Related Art

Conventional cigarettes contain many carcinogenic substances, and smoking cigarettes induces high risk of carcinogenesis.

Thus, electronic cigarettes, which generate smoke by vaporizing a nicotine liquid (e-liquid, short for electronic cigarette liquid) without other carcinogenic substances, are used to aid smoking cessation.

As the demand for electronic cigarettes grows, the electronic cigarette market has expanded and the performance and structure of electronic cigarettes have been improved.

However, consumers who do not have much experience with electronic cigarettes still feel that it is difficult to use electronic cigarettes and go back to conventional cigarettes.

Main reasons why electronic cigarette consumers find it difficult to use electronic cigarettes are leakage and backflow of liquid, and a burnt smell which occur when using electronic cigarettes.

Leakage and backflow of liquid, and a burnt smell occur when the amount of e-liquid supplied to a heater of a vaporizer serving to vaporize the e-liquid is not constant.

That is, when the supply of e-liquid to the heater is not performed well during heating of the heater of the vaporizer and thus the supply amount of e-liquid is too small, a burnt smell is generated at the heater. Conversely, when the e-liquid is continuously supplied to the heater and the e-liquid is accumulated therein, the leakage of the e-liquid occurs in which the e-liquid overflows out of the electronic cigarette, or a backflow occurs in which the e-liquid enters the mouth through an inhaler.

These problems arise in an electronic cigarette in which a vaporizer and a cartridge are integrated into one body as well as in an electronic cigarette in which a vaporizer and a cartridge are separated from each other. When too much e-liquid is supplied to the heater, the amount of e-liquid remaining after vaporization leaks or remains in a case of the electronic cigarette such that the e-liquid may frequently flow backward due to pressure generated when using the electronic cigarette.

In addition, in the case of an electronic cigarette in which a vaporizer and a cartridge are integrated into one body, when the electronic cigarette in which the e-liquid is stored in the cartridge is being stocked, the e-liquid may leak through an air passage, leading to contamination of a surface of the electronic cigarette.

### DOCUMENTS OF RELATED ART

(Patent Document 1) Korean Patent Application Publication No. 10-2016-0110670, published on Sep. 22, 2016.

### SUMMARY OF THE INVENTION

Accordingly, the present invention has been made keeping in mind the above problems occurring in the related art, and an objective of the present invention is to provide a disposable cartomizer and an electronic cigarette including the same, the disposable cartomizer being configured such that liquid is stored in a container in a sealed state whereby the liquid is prevented from leaking while being stocked, and the disposable cartomizer being also configured such that when a vaporizer is moved upward to use the cartomizer, the liquid is introduced into the vaporizer while the sealed state of the container is maintained and, at the same time, a lower end portion of a main body is sealed, thereby preventing the liquid from leaking to the outside.

In order to achieve the above objective, according to an aspect of the present invention, there is provided a disposable cartomizer including: a main body configured with a container where liquid is stored, and an air passage; and a vaporizer provided in the container in a vertically movable manner and provided with a heater therein, which generates heat with supplied power to atomize the liquid introduced from the container. When the vaporizer is moved downward, the liquid is stored in the container in a sealed state. When the vaporizer is moved upward, the liquid is introduced into the vaporizer while the sealed state of the container is maintained, and air is introduced into the vaporizer through the air passage while a lower portion of the main body is sealed.

The main body may include: an inner tube configured with a first protrusion reduced in diameter and provided at a middle portion of the container and configured with a hermetic retention recess enlarged in diameter and provided below the first protrusion; and an outer tube surrounding the inner tube and configured with a second protrusion reduced in diameter and provided below the inner tube. The vaporizer may include: an inhaler provided in the container in a vertically movable manner; a first opening and closing part coupled to a lower portion of the inhaler and brought into close contact with or separated from the first protrusion; a second opening and closing part provided below the first opening and closing part in a manner being coupled to the lower portion of the inhaler and being in close contact with the hermetic retention recess; and a third opening and closing part provided below the second opening and closing part in a manner being coupled to the lower portion of the inhaler and brought into close contact with or separated from the second protrusion. When the vaporizer is moved downward, the first opening and closing part may be brought into close contact with the first protrusion such that the liquid is stored in the container in a sealed state. When the vaporizer is moved upward, the second opening and closing part may be brought into close contact with the hermetic retention recess such that the liquid is introduced into the vaporizer while the sealed state of the container is maintained, and the third opening and closing part may be brought into close contact with the second protrusion such that air is introduced into the vaporizer through the air passage while the lower end portion of the main body is sealed.

The vaporizer may include: one or more liquid inlets configured between the first opening and closing part and the second opening and closing part while being spaced apart from each other at a predetermined distance along a circumferential direction; and one or more air inlets configured between the second opening and closing part and the third opening and closing part while being spaced apart from each other at a predetermined distance along the circumferential direction. When the vaporizer is moved upward, the sealed state of the container may be maintained by the second opening and closing part while the lower end portion of the main body is sealed by the third opening and closing part, and the liquid may be introduced into the vaporizer through the liquid inlets, and air introduced into the air passage may be supplied into the vaporizer through the air inlets.

The air passage may include: one or more guide recesses configured longitudinally on at least one of an outer circumferential surface of the inner tube and an inner circumferential surface of the outer tube while being spaced apart from each other by a predetermined distance in the circumferential direction. The guide recesses may guide an air flow such that the outside air is introduced through an air inflow portion provided at an upper side of the guide recesses and flows into the vaporizer through an air outflow portion provided at a lower side of the guide recesses.

The vaporizer may include: a fitting recess configured on an outer circumferential surface of each of the first opening and closing part, the second opening and closing part, and the third opening and closing part along the circumferential direction; and a hermetic retention member each fitted into the fitting recess to maintain airtightness between the first opening and closing part and the first protrusion, between the second opening and closing part and the hermetic retention recess, and between the third opening and closing part and the second protrusion.

The inner tube may be configured with one or more engaging protrusions on an outer circumferential surface thereof, and the outer tube may be configured with one or more engaging recesses, in which the engaging protrusions are fitted, at positions corresponding to the engaging protrusions.

In order to achieve the above objective, according to another aspect of the present invention, there is provided an electronic cigarette including: the disposable cartomizer; a housing configured with a socket into which the disposable cartomizer is inserted and a display window showing a level of the liquid contained in the disposable cartomizer; a battery provided in the housing and supplying power to the heater in response to an operation of a button; a display unit provided in the housing and displaying information on a remaining charged amount of the battery; and a controller provided in the housing and controlling the display unit to show various information on the display unit.

According to the embodiment of the present invention, the first opening and closing part is brought into close contact with the first protrusion so that the liquid is stored in the container in a sealed state, so it is possible to prevent the liquid from leaking while being stocked. In addition, when the vaporizer is moved upward to use the cartomizer, the second opening and closing part is brought into close contact with the hermetic retention recess so that the liquid is introduced into the vaporizer while the sealed state of the container is maintained, and, at the same time, the third opening and closing part is brought into close contact with the second protrusion, the lower end portion of the main body is sealed, thereby preventing the liquid from leaking to the outside.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view illustrating a disposable cartomizer according to an embodiment of the present invention;

FIG. 2 is a sectional view illustrating the disposable cartomizer according to the embodiment of the present invention;

FIG. 3 is a perspective view illustrating the disposable cartomizer according to the embodiment of the present invention in use;

FIG. 4 is a sectional view illustrating the disposable cartomizer according to the embodiment of the present invention in use;

FIG. 5 is a sectional view illustrating a main body of the disposable cartomizer according to the embodiment of the present invention;

FIG. 6 is a plan view illustrating a main body of the disposable cartomizer according to the embodiment of the present invention;

FIG. 7 is a perspective view illustrating a vaporizer of the disposable cartomizer according to the embodiment of the present invention;

FIG. 8 is a sectional view illustrating a disposable cartomizer according to another embodiment of the present invention in use;

FIG. 9 is a sectional view illustrating an electronic cigarette incorporated with the disposable cartomizer according to the embodiment of the present invention; and

FIG. 10 is a front view illustrating the electronic cigarette from which the disposable cartomizer according to the embodiment of the present invention is separated.

### DETAILED DESCRIPTION OF THE INVENTION

Contents of the description below merely exemplify the principle of the invention. Hereinbelow, some embodiments of the present invention will be described in detail with reference to exemplary drawings. As for reference numerals associated with parts in the drawings, the same reference numerals will refer to the same or like parts through the drawings. In the following description, it is to be noted that, when the functions of conventional elements and the detailed description of elements related with the present invention may make the gist of the present invention unclear, a detailed description of those elements will be omitted.

Further, when describing the components of the present invention, terms such as first, second, A, B, (a) or (b) may be used. Since these terms are provided merely for the purpose of distinguishing the components from each other, they do not limit the nature, sequence, or order of the components. It will be understood that when an element is referred to as being “coupled” or “connected” to another element, it can be directly coupled or connected to the other element or intervening elements may be present therebetween.

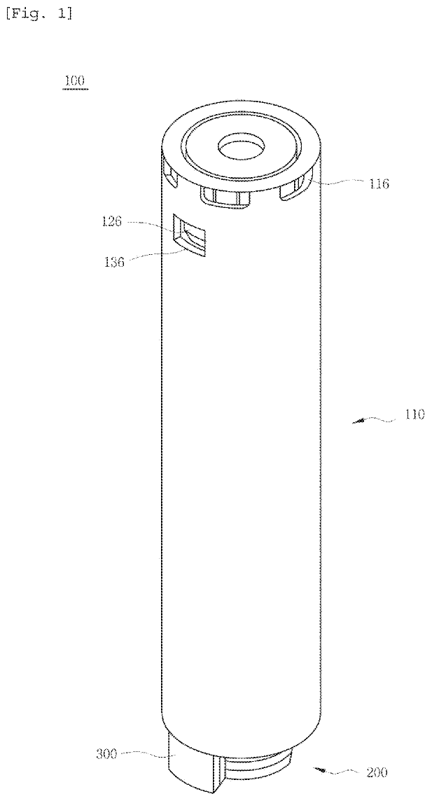

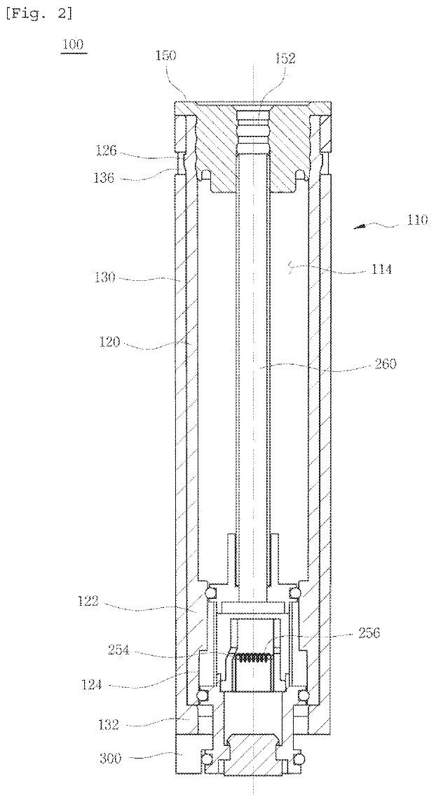

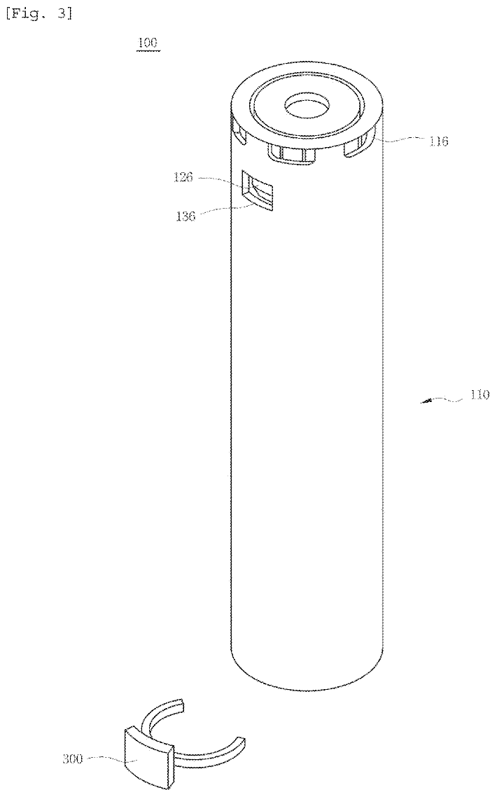

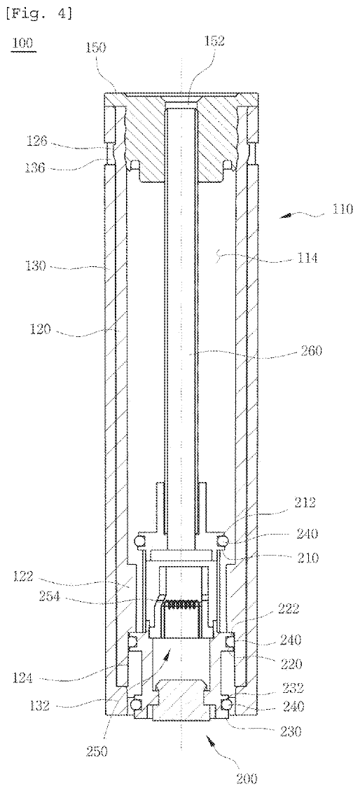

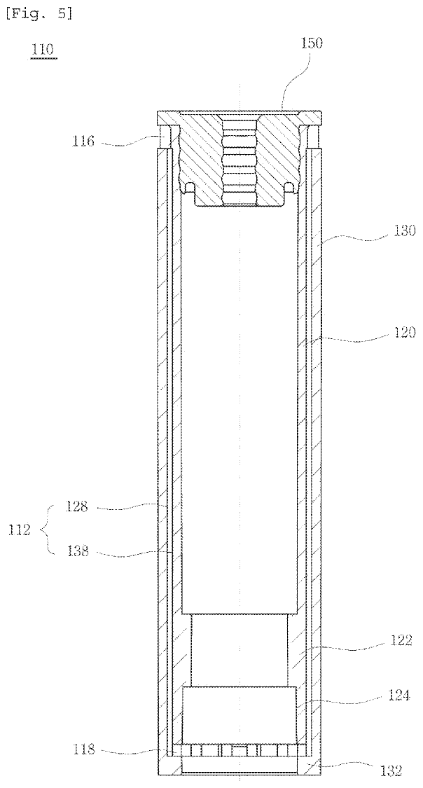

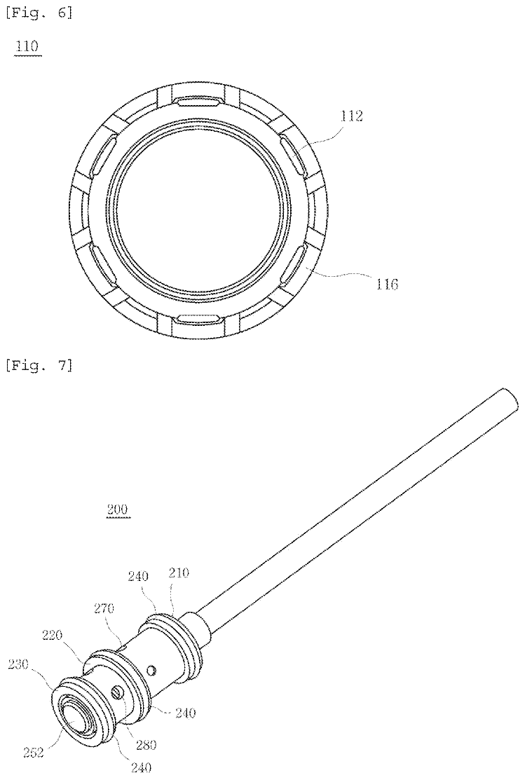

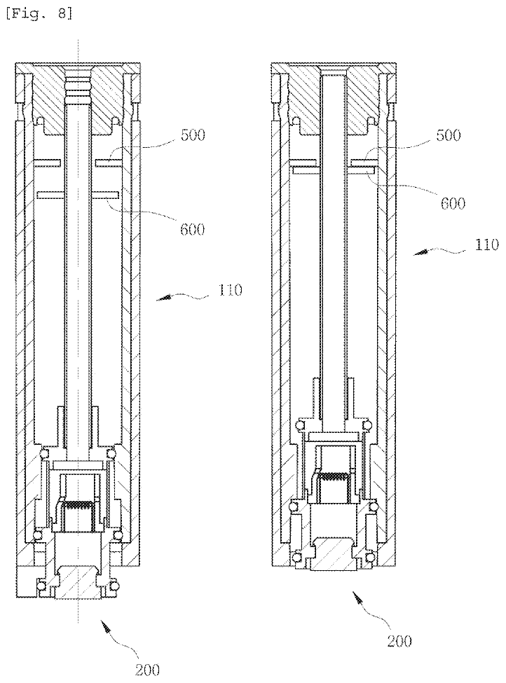

FIG. 1 is a perspective view illustrating a disposable cartomizer according to an embodiment of the present invention; FIG. 2 is a sectional view illustrating the disposable cartomizer according to the embodiment of the present invention; FIG. 3 is a perspective view illustrating the disposable cartomizer according to the embodiment of the present invention in use; FIG. 4 is a sectional view illustrating the disposable cartomizer according to the embodiment of the present invention in use; FIG. 5 is a sectional view illustrating a main body of the disposable cartomizer according to the embodiment of the present invention; FIG. 6 is a plan view illustrating a main body of the disposable cartomizer according to the embodiment of the present invention; and FIG. 7 is a perspective view illustrating a vaporizer of the disposable cartomizer according to the embodiment of the present invention.

As illustrated in the drawings, a disposable cartomizer 100 according to an embodiment of the present invention includes: a main body 110 configured with a container 114 where liquid is stored and air passages 112; and a vaporizer 200 provided in the container 114 in a vertically movable manner and provided with a heater 250 therein, which generates heat with supplied power to atomize the liquid introduced from the container 114. When the vaporizer 200 is moved downward, the liquid is stored in the container 114 in a sealed state. When the vaporizer 200 is moved upward, the liquid is introduced into the vaporizer 200 while the sealed state of the container 114 is still maintained, and air is supplied into the vaporizer 200 through the air passages 112 while a lower end portion of the main body 110 is sealed.

The main body 110 is configured with the container 114 where the liquid is stored and the air passages 112. The vaporizer 200 is provided in the container 114 in a vertically movable manner and provided with the heater 250 therein, which generates heat with supplied power to atomize the liquid introduced from the container 114.

More specifically, the main body 110 includes: an inner tube 120 configured with a first protrusion 122 reduced in diameter and provided at a middle portion of the container 114 and configured with a hermetic retention recess 124 enlarged in diameter and provided below the first protrusion 122; and an outer tube 130 surrounding the inner tube 120 and configured with a second protrusion 132 reduced in diameter and provided below the inner tube 120. The vaporizer 200 includes: an inhaler 260 provided in the container 114 in a vertically movable manner; a first opening and closing part 210 coupled to a lower portion of the inhaler 260 and brought into close contact with or separated from the first protrusion 122; a second opening and closing part 220 provided below the first opening and closing part 210 in a manner being coupled to the lower portion of the inhaler 260 and being in close contact with the hermetic retention recess 124; and a third opening and closing part 230 provided below the second opening and closing part 220 in a manner being coupled to the lower portion of the inhaler 260 and brought into close contact with or separated from the second protrusion 132.

According to the present invention, when the vaporizer 200 is moved downward, the first opening and closing part 210 is brought into close contact with the first protrusion 122 such that the liquid is stored in the container 114 in a sealed state. When the vaporizer 200 is moved upward, the second opening and closing part 220 is brought into close contact with the hermetic retention recess 124 such that the liquid is introduced into the vaporizer 200 while the sealed state of the container 114 is still maintained. In addition, when the vaporizer 200 is moved upward, the third opening and closing part 230 is brought into close contact with the second protrusion 132 such that air is supplied into the vaporizer 200 through the air passages 112 while the lower end portion of the main body 110 is sealed.

The main body 110 according to the present invention includes the inner tube 120 and the outer tube 130, wherein the inner tube 120 is configured with the container 114 where the liquid is stored, the first protrusion 122 reduced in diameter and provided at the middle portion of the container 114, and the hermetic retention recess 124 enlarged in diameter and provided at the lower side of the first protrusion 122.

In addition, the outer tube 130 surrounds the inner tube 120 and is configured with the second protrusion 132 reduced in diameter and provided at the lower side of the inner tube 120.

Here, the air passages 112 are configured between the inner tube 120 and the outer tube 130 to guide a flow of air such that the outside air is introduced through air inflow portions 116 provided at each upper portion of the air passages 112 and flows into the vaporizer 200 through air outflow portions 118 provided at each lower portion of the air passages 112.

Each of the air passages 112 according to the present invention includes one or more guide recesses configured longitudinally on at least one of an outer circumferential surface of the inner tube 120 and an inner circumferential surface of the outer tube 130 while being spaced apart from each other by a predetermined distance in the circumferential direction. Here, air is guided to flow such that the outside air is introduced through the air inflow portions 116 provided at an upper side of the guide recesses and flows into the vaporizer 200 through the air outflow portions 118 provided at a lower side of the guide recesses.

More specifically, one or more guide recesses 128 are configured longitudinally on the outer circumferential surface of the inner tube 120 in a manner being spaced apart from each other at a predetermined distance in the circumferential direction. In addition, one or more guide recesses 138 are configured longitudinally on the inner circumferential surface of the outer tube 130 in a manner being spaced apart from each other at the predetermined distance in the circumferential direction to correspond to the guide recesses 128 of the inner tube 120.

Here, the main body 110 according to the present invention is configured such that six air passages 112 are spaced apart from each other at a predetermined distance in the circumferential direction, and one air inflow portion 116 and one air outflow portion 118 are configured at an upper side of each of the air passages 112 and at a lower side of each of the air passages 112, respectively.

Accordingly, the air passages 112 guide air to flow downwardly such that the outside air is introduced into the air inflow portions 116 provided at an upper side of each of the guide recesses 128 and 138 and flows into the vaporizer 200 through the air outflow portions 118 provided at a lower side of each of the guide recesses 128 and 138.

Here, according to the present invention, at least one engaging protrusion 126 is configured on the outer circumferential surface of the inner tube 120. At least one engaging recess 136 in which the engaging protrusion 126 is fitted is configured in the outer tube 130 at a position corresponding to the engaging protrusion 126. Accordingly, as the engaging protrusion 126 of the inner tube 120 is fitted into the engaging recess 136 of the outer tube 130, the inner tube 120 and the outer tube 130 are joined together rather being separated from each other such that the air passages 112 are provided therebetween.

The vaporizer 200 includes: the inhaler 260 extending from the top to the bottom of the main body 110 and provided in the container 114 in a vertically movable manner; the first opening and closing part 210; the second opening and closing part 220; and the third opening and closing part 230. In addition, the vaporizer 200 is provided with the heater 250 therein, the heater 250 generating heat with power supplied from a battery 20 to atomize the liquid introduced from the container 114. The heater 250 includes: an adsorption member 254 adsorbing the liquid introduced from the container 114; and a heater coil 256 wound around the adsorption member 254 and generating heat with the power supplied from the battery 20.

The adsorption member 254 is made of ceramic fiber and adsorbs the liquid introduced from the container 114.

The heater coil 256 is wound around the adsorption member 254 and generates heat with power supplied from the battery 20 to vaporize the liquid adsorbed on the adsorption member 254.

Here, a controller 24 controls the heating value of the heater coil 256 according to the amount of liquid adsorbed on the adsorption member 254.

The inhaler 260 is provided in the container 114 in a vertically movable manner. The first opening and closing part 210 is coupled to the lower portion of the inhaler 260 and brought into close contact with or separated from the first protrusion 122. The second opening and closing part 220 is provided below the first opening and closing part 210 in a manner being coupled to the lower portion of the inhaler 260 and being in close contact with the hermetic retention recess 124. The third opening and closing part 230 is provided below the second opening and closing part 220 in a manner being coupled to the lower portion of the inhaler 260 and brought into close contact with or separated from the second protrusion 132.

Here, the first opening and closing part 210, the second opening and closing part 220, and the third opening and closing part 230 have fitting recesses 212, 222, and 232, respectively, which are configured on outer circumferential surfaces thereof, respectively, along the circumferential direction. Hermetic retention members 240 are fitted into the fitting recesses 212, 222, and 232, individually to maintain airtightness between the first opening and closing part 210 and the first protrusion 122, between the second opening and closing part 220 and the hermetic retention recess 124, and between the third opening and closing part 230 and the second protrusion 132.

In addition, the vaporizer 200 includes: one or more liquid inlets 270 configured between the first opening and closing part 210 and the second opening and closing part 220 while being spaced apart from each other at a predetermined distance along the circumferential direction; and one or more air inlets 280 configured between the second opening and closing part 220 and the third opening and closing part 230 while being spaced apart from each other at a predetermined distance along the circumferential direction.

More specifically, the vaporizer 200 according to the present invention has four liquid inlets 270 configured between the first opening and closing part 210 and the second opening and closing part 220 while being spaced apart from each other along the circumferential direction, and has four air inlets 280 configured between the second opening and closing part 220 and the third opening and closing part 230 while being spaced apart from each other along the circumferential direction.

Thus, according to the present invention, when the vaporizer 200 is moved downward, the liquid is stored in the container 114 in a sealed state. When the vaporizer 200 is moved upward, the liquid is introduced into the vaporizer 200 while the sealed state of the container 114 is still maintained, and air is supplied into the vaporizer 200 through the air passages 112 while the lower end portion of the main body 110 is sealed.

In other words, when the vaporizer 200 is moved downward, the first opening and closing part 210 is brought into close contact with the first protrusion 122 such that the liquid is stored in the container 114 in a sealed state. When the vaporizer 200 is moved upward, the second opening and closing part 220 is brought into close contact with the hermetic retention recess 124 such that the liquid is introduced into the vaporizer 200 while the sealed state of the container 114 is still maintained. In addition, when the vaporizer 200 is moved upward, the third opening and closing part 230 is brought into close contact with the second protrusion 132 such that air is supplied into the vaporizer 200 through the air passages 112 while the lower end portion of the main body 110 is sealed.

That is, when the vaporizer 200 is moved upward, the sealed state of the container 114 is maintained by the second opening and closing part 220 while the lower end portion of the main body 110 is sealed by third opening and closing part 230. Accordingly, the liquid is introduced into the vaporizer 200 through the liquid inlets 270, and air introduced into the air passages 112 is supplied into the vaporizer 200 through the air inlets 280.

A stopper 150 is made of rubber or silicone material, and an outlet 152 with which the inhaler 260 communicates is configured.

The stopper 150 is coupled to an upper end of the main body 110 so that the liquid is stored in the container 114 in a sealed state. An outer circumferential surface of the stopper 150 is brought into close contact with the inner circumferential surface of the inner tube 120, and the outlet 152 and the inhaler 260 communicate with each other.

According to the present invention, in order to increase airtightness, one or more threads are configured circumferentially on the outer circumferential surface of the stopper 150 in a manner being spaced apart from each other at a predetermined distance in the longitudinal direction and protruding outward. One or more threads are configured circumferentially on the outlet 152 in a manner being spaced apart from each other at a predetermined distance in the longitudinal direction and protruding inward.

In order to prevent the liquid from leaking to the outside while being stocked in a state in which the vaporizer 200 is moved downward to be filled with the liquid, a safety pin 300 is interposed between the main body 110 and the vaporizer 200, that is, between a lower end of the outer tube 130 and an upper end of the third opening and closing part 230, to hold the vaporizer 200.

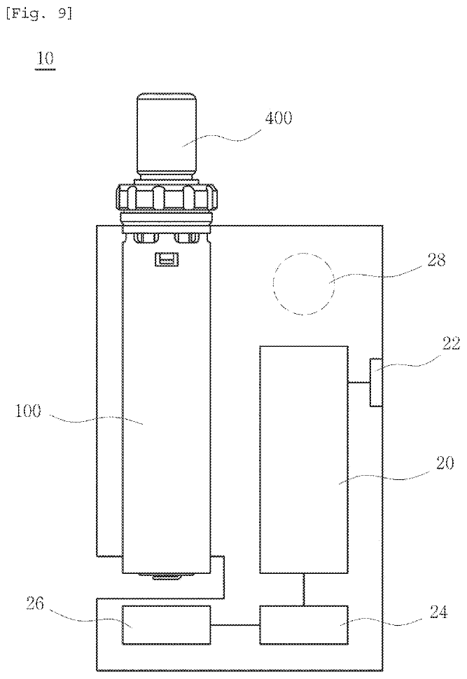

FIG. 8 is a sectional view illustrating a disposable cartomizer according to another embodiment of the present invention in use.

According to another embodiment of the present invention, a disposable cartomizer 100 includes: an electromagnet 500 coupled to an inner side surface of the inner tube 120 and magnetized when power is supplied and not magnetized when the power supply is interrupted; and a metal member 600 disposed below the electromagnet 500 and coupled to an outer side surface of the inhaler 260.

As illustrated in FIG. 8, in the disposable cartomizer 100, the power supplied to the electromagnet 500 is interrupted so that the first opening and closing part 210 of the vaporizer 200 is brought into close contact with the first protrusion 122 of the main body 110, and the vaporizer 200 is held thereby. To use the cartomizer, power is supplied to the electromagnet 500 such that the metal member 600 is brought into close contact with the electromagnet 500 while the third opening and closing part is brought into close contact with the second protrusion, thereby moving the vaporizer upward.

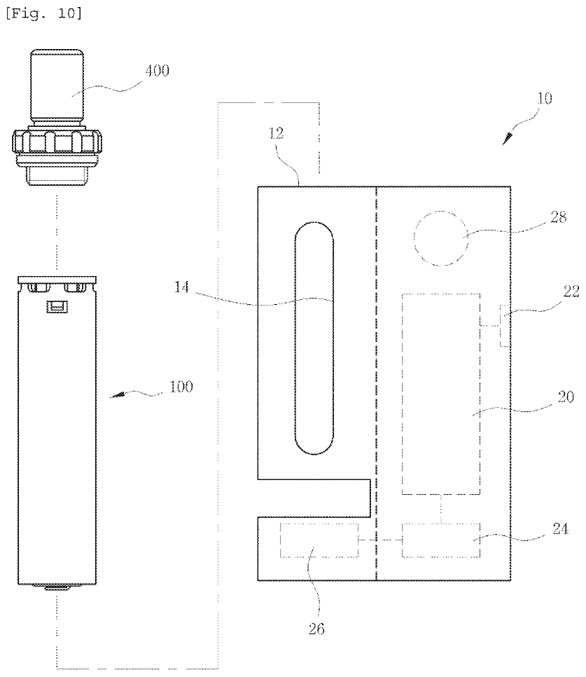

FIG. 9 is a sectional view illustrating an electronic cigarette incorporated with the disposable cartomizer according to the embodiment of the present invention; and FIG. 10 is a front view illustrating the electronic cigarette from which the disposable cartomizer according to the embodiment of the present invention is separated.

As illustrated in the drawings, an electronic cigarette 10 according to the embodiment of the present invention includes: the disposable cartomizer 100; a housing configured with a socket 12 into which the disposable cartomizer 100 is inserted and with a display window 14 showing a level of the liquid contained in the disposable cartomizer 100; the battery 20 provided in the housing and supplying power to the heater 250 in response to an operation of a button 28; a display unit provided in the housing and displaying information on a remaining charged amount of the battery 20; and the controller 24 provided in the housing and controlling the display unit to show various information on the display unit.

The housing is configured with the socket 12 into which the disposable cartomizer 100 is inserted. In addition, the housing is configured with the display window 14 showing a level of the liquid contained in the disposable cartomizer 100.

The housing is provided with the battery 20 supplying power to the heater 250 in response to an operation of the button 28. In addition, the housing is provided with the controller 24 controlling the display unit to show various information on the display unit.

The heater 250 receives power from the battery 20 via a terminal 252 provided at a lower portion of the disposable cartomizer 100 and a terminal 26 provided below the socket of the housing.

The housing is provided with the display unit to display information on a remaining charged amount of the battery 20. The housing is provided with a charging terminal 22 to charge the battery 20 with an external power source.

Here, the controller 24 may allow the display unit to display the number of inhalations, the number of cigarettes corresponding to the number of inhalations, etc. by pressing the button 28 and may allow an alarm unit to display an alert or alarm when the number of cigarettes reaches a predetermined limit value.

A drip tip 400 is pipe-shaped so that a user bites onto the drip tip 400 and inhales. The drip tip 400 is detachably coupled to the socket 12 of the housing and communicates with the outlet 152 of the stopper 150.

An operation of the present invention constructed as described above will be described hereinbelow.

The vaporizer 200 is installed in the container 114 of the main body 110 in a vertically movable manner, and the vaporizer 200 is moved downward so that the first opening and closing part 210 of the vaporizer 200 is brought into closed contact with the first protrusion 122 of the main body 110.

Then, the safety pin 300 is inserted between the main body 110 and the vaporizer 200 so as to be supported on the lower end of the outer tube 130 and the upper end of the third opening and closing part 230, thereby holding the vaporizer 200.

The container 114 is filled with the liquid in a state where the vaporizer 200 is held, and the stopper 150 is inserted in the top of the main body 110 so that the inhaler 260 of the vaporizer 200 and the outlet 152 of the stopper 150 communicate with each other.

As described above, when the vaporizer 200 is held by the safety pin 300 so that the first opening and closing part 210 of the vaporizer 200 is brought into close contact with the first protrusion 122 of the main body 110, and when the stopper 150 is coupled to the top of the main body 110 so that the liquid is stored in the container 114 in the sealed state, it is possible to prevent the liquid from leaking while being stocked.

To use the electronic cigarette 10 assembled with the disposable cartomizer 100, the safety pin 300 inserted between the main body 110 and the vaporizer 200 is removed, and the bottom of the vaporizer 200 is pushed to move the vaporizer 200 such that the third opening and closing part 230 is brought into close contact with the second protrusion 132.

When the vaporizer 200 is pushed upward, the liquid flows into a gap between the first opening and closing part and the first protrusion 122, flows into the vaporizer 200 through the liquid inlet 270, and is stored in the container 114 in a sealed state without leakage because of the second opening and closing part 220 being in close contact with the hermetic retention recess 124.

At the same time, air is introduced into the air passages 112 by the third opening and closing part 230 brought into close contact with the second protrusion 132 and flows into the vaporizer 200 through the air inlets 280.

Here, even when a large amount of liquid flows into the vaporizer 200, the third opening and closing part 230 brought into close contact with the second protrusion 132 prevents the liquid from leaking to the outside.

In addition, since the air inflow portions are provided at the upper portion of the main body 110, it is possible to fundamentally prevent the liquid from flowing backward through the air passages 112.

The disposable cartomizer 100 with the liquid flowing into the vaporizer 200 is inserted into the socket 12 of the electronic cigarette 10, and the drip tip 400 is coupled to the socket 12 of the housing so that the drip tip 400 communicates with the outlet 152 of the stopper 150.

Accordingly, the terminal 252 of the disposable cartomizer 100 and the terminal 26 of the electronic cigarette 10 are connected to each other electrically so that power of the battery 20 is supplied to the heater coil 256.

That is, the disposable cartomizer 100 is held inside the electronic cigarette 10 by the drip tip 400 coupled to the electronic cigarette 10 and thus supplied with power of the battery 20.

Accordingly, when a user presses the button 28 of the electronic cigarette 10 to supply power to the heater coil 256, the liquid adsorbed on the adsorption member 254 is vaporized by heat of the heater coil 256, thereby forming vapor, and the user can smoke by inhaling the vapor and exhaling the vapor.

The controller 24 is provided with a charging circuit and charges the battery 20 with external power supplied via the charging terminal 22 when the battery 20 is in a discharged state.

As described above, according to the present invention, as the first opening and closing part 210 is brought into close contact with the first protrusion 122 so that the liquid is stored in the container 114 in a sealed state, it is possible to prevent the liquid from leaking while being stocked. When the vaporizer 200 is moved upward to use the electronic cigarette, the second opening and closing part 220 is brought into close contact with the hermetic retention recess 124 so that the sealed state of the container 114 is maintained and the liquid is introduced into the vaporizer 200. In addition, as the third opening and closing part 230 is brought into close contact with the second protrusion 132, the lower end portion of the main body 110 is sealed and thus the liquid is prevented from leaking to the outside.

In the description above, although all of the components of the embodiments of the present invention may have been explained as assembled or operatively connected as a unit, the present invention is not intended to limit itself to such embodiments. Rather, within the objective scope of the present invention, the respective components may be selectively and operatively combined in any numbers.

In addition, terms like “include”, “comprise”, “have”, etc. should be interpreted in default as inclusive or open rather than exclusive or closed unless expressly defined to the contrary. Unless otherwise defined, all the terms including technical and scientific terms used herein have the same meaning as commonly understood by one of ordinary skill in the art to which this invention belongs. Terms, such as those defined in commonly used dictionaries, should be interpreted as having a meaning that is consistent with their meaning in the context of the relevant art and the present invention, and not be interpreted in an idealized or overly formal sense unless expressly so defined herein.

Although exemplary aspects of the present invention have been described for illustrative purposes, those skilled in the art will appreciate that various modifications, additions, and substitutions are possible, without departing from essential characteristics of the present invention. Therefore, exemplary aspects of the present invention have not been described for limiting purposes. Accordingly, the scope of the present invention is not to be limited by the above aspects but by the claims and the equivalents thereof.

What is claimed is:

1. A disposable cartomizer, comprising:
a main body configured with a container where liquid is stored, and an air passage; and
a vaporizer provided in the container in a vertically movable manner and provided with a heater therein, which generates heat with supplied power to atomize the liquid introduced from the container,
wherein, when the vaporizer is moved downward, the liquid is stored in the container in a sealed state, and
when the vaporizer is moved upward, the liquid is introduced into the vaporizer while the sealed state of the container is maintained, and air is introduced into the vaporizer through the air passage while a lower portion of the main body is sealed.

2. The disposable cartomizer of claim 1, wherein the main body includes:
an inner tube configured with a first protrusion reduced in diameter and provided at a middle portion of the container and configured with a hermetic retention recess enlarged in diameter and provided below the first protrusion; and
an outer tube surrounding the inner tube and configured with a second protrusion reduced in diameter and provided below the inner tube, and
the vaporizer includes:
an inhaler provided in the container in a vertically movable manner;
a first opening and closing part coupled to a lower portion of the inhaler and brought into close contact with or separated from the first protrusion;
a second opening and closing part provided below the first opening and closing part in a manner being coupled to the lower portion of the inhaler and being in close contact with the hermetic retention recess; and
a third opening and closing part provided below the second opening and closing part in a manner being coupled to the lower portion of the inhaler and brought into close contact with or separated from the second protrusion,
wherein, when the vaporizer is moved downward, the first opening and closing part is brought into close contact with the first protrusion such that the liquid is stored in the container in a sealed state, and
when the vaporizer is moved upward, the second opening and closing part is brought into close contact with the hermetic retention recess such that the liquid is introduced into the vaporizer while the sealed state of the container is maintained, and the third opening and closing part is brought into close contact with the second protrusion such that air is introduced into the vaporizer through the air passage while the lower end portion of the main body is sealed.

3. The disposable cartomizer of claim 2, wherein the vaporizer includes:
one or more liquid inlets configured between the first opening and closing part and the second opening and closing part while being spaced apart from each other at a predetermined distance along a circumferential direction; and
one or more air inlets configured between the second opening and closing part and the third opening and closing part while being spaced apart from each other at a predetermined distance along the circumferential direction,
wherein, when the vaporizer is moved upward, the sealed state of the container is maintained by the second opening and closing part while the lower end portion of the main body is sealed by the third opening and closing part, and the liquid is introduced into the vaporizer through the liquid inlets, and air introduced into the air passage is supplied into the vaporizer through the air inlets.

4. The disposable cartomizer of claim 2, wherein the air passage includes:
one or more guide recesses configured longitudinally on at least one of an outer circumferential surface of the inner tube and an inner circumferential surface of the outer tube while being spaced apart from each other by a predetermined distance in the circumferential direction,
wherein the guide recesses guide an air flow such that the outside air is introduced through an air inflow portion provided at an upper side of the guide recesses and flows into the vaporizer through an air outflow portion provided at a lower side of the guide recesses.

5. The disposable cartomizer of claim 2, wherein the vaporizer includes:
a fitting recess configured on an outer circumferential surface of each of the first opening and closing part, the second opening and closing part, and the third opening and closing part along the circumferential direction; and
a hermetic retention member each fitted into the fitting recess to maintain airtightness between the first opening and closing part and the first protrusion, between the second opening and closing part and the hermetic retention recess, and between the third opening and closing part and the second protrusion.

6. The disposable cartomizer of claim 2, wherein the inner tube is configured with one or more engaging protrusions on an outer circumferential surface thereof, and the outer tube is configured with one or more engaging recesses, in which the engaging protrusions are fitted, at positions corresponding to the engaging protrusions.

7. An electronic cigarette, comprising:
the disposable cartomizer of claim 1;
a housing configured with a socket into which the disposable cartomizer is inserted and a display window showing a level of the liquid contained in the disposable cartomizer;
a battery provided in the housing and supplying power to the heater in response to an operation of a button;
a display unit provided in the housing and displaying information on a remaining charged amount of the battery; and
a controller provided in the housing and controlling the display unit to show various information on the display unit.

8. The electronic cigarette of claim 7, wherein the main body includes:
an inner tube configured with a first protrusion reduced in diameter and provided at a middle portion of the container and configured with a hermetic retention recess enlarged in diameter and provided below the first protrusion; and
an outer tube surrounding the inner tube and configured with a second protrusion reduced in diameter and provided below the inner tube, and
the vaporizer includes:
an inhaler provided in the container in a vertically movable manner;
a first opening and closing part coupled to a lower portion of the inhaler and brought into close contact with or separated from the first protrusion;
a second opening and closing part provided below the first opening and closing part in a manner being coupled to the lower portion of the inhaler and being in close contact with the hermetic retention recess; and
a third opening and closing part provided below the second opening and closing part in a manner being coupled to the lower portion of the inhaler and brought into close contact with or separated from the second protrusion,
wherein, when the vaporizer is moved downward, the first opening and closing part is brought into close contact with the first protrusion such that the liquid is stored in the container in a sealed state, and
when the vaporizer is moved upward, the second opening and closing part is brought into close contact with the hermetic retention recess such that the liquid is introduced into the vaporizer while the sealed state of the container is maintained, and the third opening and closing part is brought into close contact with the second protrusion such that air is introduced into the vaporizer through the air passage while the lower end portion of the main body is sealed.

9. The electronic cigarette of claim 8, wherein the vaporizer includes:
one or more liquid inlets configured between the first opening and closing part and the second opening and closing part while being spaced apart from each other at a predetermined distance along a circumferential direction; and
one or more air inlets configured between the second opening and closing part and the third opening and closing part while being spaced apart from each other at a predetermined distance along the circumferential direction,
wherein, when the vaporizer is moved upward, the sealed state of the container is maintained by the second opening and closing part while the lower end portion of the main body is sealed by the third opening and closing part, and the liquid is introduced into the vaporizer through the liquid inlets, and air introduced into the air passage is supplied into the vaporizer through the air inlets.

10. The electronic cigarette of claim 8, wherein the air passage includes:
one or more guide recesses configured longitudinally on at least one of an outer circumferential surface of the inner tube and an inner circumferential surface of the outer tube while being spaced apart from each other by a predetermined distance in the circumferential direction,
wherein the guide recesses guide an air flow such that the outside air is introduced through an air inflow portion provided at an upper side of the guide recesses and flows into the vaporizer through an air outflow portion provided at a lower side of the guide recesses.

11. The electronic cigarette of claim 8, wherein the vaporizer includes:
a fitting recess configured on an outer circumferential surface of each of the first opening and closing part, the second opening and closing part, and the third opening and closing part along the circumferential direction; and
a hermetic retention member each fitted into the fitting recess to maintain airtightness between the first opening and closing part and the first protrusion, between the second opening and closing part and the hermetic retention recess, and between the third opening and closing part and the second protrusion.

12. The electronic cigarette of claim 8, wherein the inner tube is configured with one or more engaging protrusions on an outer circumferential surface thereof, and the outer tube is configured with one or more engaging recesses, in which the engaging protrusions are fitted, at positions corresponding to the engaging protrusions.
